(19) United States
(12) Patent Application Publication
(10) Pub. No.: US 2025/0334689 A1
(43) Pub. Date: Oct. 30, 2025

(54) KICK SENSOR

(71) Applicant: AISIN CORPORATION, Kariya (JP)

(72) Inventors: Masaki MATSUSHIMA, Kariya-shi (JP); Tetsuya SHIOTSU, Kariya-shi (JP)

(73) Assignee: AISIN CORPORATION, Kariya (JP)

(21) Appl. No.: 19/081,242

(22) Filed: Mar. 17, 2025

(30) Foreign Application Priority Data
Apr. 25, 2024 (JP) 2024-071481

(51) Int. Cl. G01S 13/50; E05F 15/73

(52) U.S. Cl. CPC G01S 13/50; E05F 15/73; E05Y 2400/44; E05Y 2400/664; E05Y 2900/546

(57) ABSTRACT

A kick sensor is provided in a vehicle. and detects a motion of a leg of a person that triggers control of a door of the vehicle. The kick sensor includes first and second antennas. The first antenna receives a radio wave from at least a lateral side of the door of the vehicle. The second antenna receives a radio wave from at least a lower side of the door of the vehicle.

### CROSS REFERENCE TO RELATED APPLICATIONS

This application is based on and claims priority under 35 U.S.C. § 119 to Japanese Patent Application 2024-071481, filed on Apr. 25, 2024, the entire content of which is incorporated herein by reference.

### TECHNICAL FIELD

This disclosure generally relates to a kick sensor being provided in a vehicle and detecting a motion of a leg of a person that serves as a trigger for controlling a door of the vehicle.

### BACKGROUND DISCUSSION

A door opening-closing device is conventionally used, having a function of automatically locking and unlocking a vehicle door or automatically opening and closing the vehicle door. An example of such a door opening-closing device is described in JP2019-116824A (Reference 1).

The door opening-closing device described in Reference 1 includes a non-contact detection unit for detecting presence of a user at a position near a vehicle door, switching the vehicle door from a locked state to an unlocked state, and then opening the door. The detection unit includes a detection sensor being attached near the door and detecting an detection target object at a position on a lower side of the door.

The door opening-closing device described in Reference 1 is configured in such a way that the detection sensor detects a detection target object at a position on a lower side of the door. For this reason, there is a possibility that, even when the detection sensor detects, within a detection range, a cat or the like or a person (a leg of the person) who has no intention of opening the door, the door is erroneously opened.

A need thus exists for a kick sensor, which is not susceptible to the drawback mentioned above.

### SUMMARY

A kick sensor according to an aspect of this disclosure is provided in a vehicle, and detects a motion of a leg of a person that triggers control of a door of the vehicle. The kick sensor includes first and second antennas. The first antenna receives a radio wave from at least a lateral side of the door of the vehicle. The second antenna receives a radio wave from at least a lower side of the door of the vehicle.

### BRIEF DESCRIPTION OF THE DRAWINGS

The foregoing and additional features and characteristics of this disclosure will become more apparent from the following detailed description considered with the reference to the accompanying drawings, wherein:

FIG. 1 illustrates a vehicle provided with a kick sensor;

FIG. 2 is a plan view of the kick sensor;

FIG. 3 illustrates a directivity characteristic of a first antenna;

FIG. 4 illustrates a directivity characteristic of a second antenna;

FIG. 5 illustrates a mode of inputting an opening-closing instruction by a leg of a person;

FIG. 6 is a plan view of a kick sensor according to another embodiment;

FIG. 7 is a plan view of a kick sensor according to still another embodiment;

FIG. 8 is a plan view of a kick sensor according to yet another embodiment; and

FIG. 9 illustrates switching between a first state and a second state.

### DETAILED DESCRIPTION

A kick sensor according to this disclosure can detect an operation instruction for switching a state of a vehicle door or a door lock. The following describes the kick sensor 1 according to this embodiment. However, the kick sensor 1 is not limited to the following embodiment, and can be variously modified without departing from the essence.

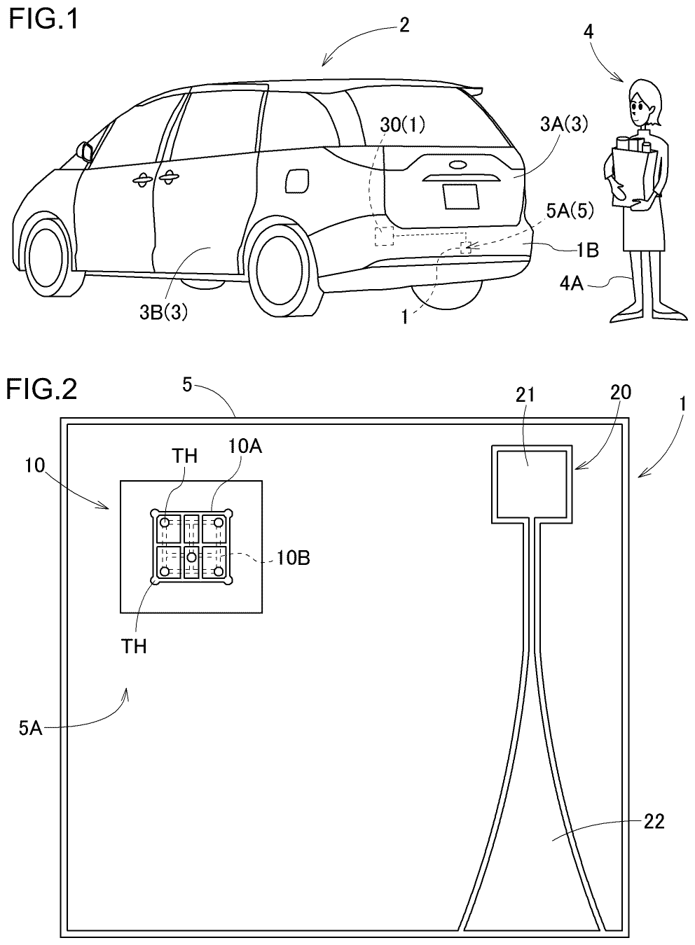

As illustrated in FIG. 1, the kick sensor 1 is provided in the vehicle 2. As described above, the kick sensor 1 detects an operation instruction for switching a state of the door 3 or a door lock of the vehicle 2. The door 3 of the vehicle 2 corresponds to the door 3 provided in the vehicle 2 and allowed to be opened and closed by an actuator. Specific examples of the door 3 include a back door 3A (rear gate) provided at a rear of the vehicle 2 and a slide door 3B provided at a side of the vehicle 2. The door lock corresponds to a mechanism provided at such a door 3 and switchable between a locking state of preventing the door 3 from being opened and an unlocking state of allowing the door 3 to be opened. In the following description, the back door 3A is cited as an example of the door 3 of the vehicle 2.

Switching a state of the door 3 or the door lock of the vehicle 2 means controlling the door 3 of the vehicle 2. Specifically, switching a state of the door 3 means both of switching the door 3 of the vehicle 2 in an opened state to be in a closed state and switching the door 3 of the vehicle 2 in a closed state to be in an opened state. Further, switching a state of the door lock means both of switching the door lock in a locking state to be in an unlocking state and switching the door lock in an unlocking state to be in a locking state. The operation instruction corresponds to an instruction that is input by a person 4 and that triggers the control of switching a state of the door 3 or the door lock of the vehicle 2. Such an instruction is input by a motion of a leg 4A of the person 4.

Thus, the kick sensor 1 is configured in such a way as to detect an instruction that is input by a motion of the leg 4A of the person 4 and that serves as a trigger for switching the back door 3A of the vehicle 2 in an opened state to be in a closed state, and an instruction that is input by a motion of the leg 4A of the person 4 and that serves as a trigger for switching the back door 3A of the vehicle 2 in a closed state to be in an opened state. Further, the kick sensor 1 is configured in such a way as to detect an instruction that is input by a motion of the leg 4A of the person 4 and that serves as a trigger for switching the door lock in a locking state to be in an unlocking state, and an instruction that is input by a motion of the leg 4A of the person 4 and that serves as a trigger for switching the door lock in an unlocking state to be in a locking state.

FIG. 2 illustrates a plan view of the kick sensor 1. As illustrated in FIG. 1 and FIG. 2, the kick sensor 1 includes a first antenna 10, a second antenna 20, and a control unit 30. The first antenna 10 receives a radio wave from at least a lateral side of the door 3 of the vehicle 2. A lateral side of the door 3 of the vehicle 2 means a direction along a horizontal direction from a center that is the door 3 of the vehicle 2, and includes not only both vehicle-width-direction sides (a left side and a right side) of the vehicle 2, but also a rear side of the vehicle 2. In this embodiment, description is made on the assumption that the lateral side of the door 3 of the vehicle 2 is a rear side of the back door 3A of the vehicle 2. Accordingly, the first antenna 10 in this embodiment receives, as a radio wave from a lateral side of the door 3 of the vehicle 2, a radio wave propagating through the air from a rear side of the back door 3A of the vehicle 2.

In this embodiment, the first antenna 10 is configured as a patch antenna (microstrip antenna). The first antenna 10 is configured as a pattern formed in a substrate 5. The substrate 5 is configured as a multilayer printed circuit board (a printed circuit board including four conductor layers in this embodiment). Assuming that the four conductor layers are the first conductor layer, the second conductor layer, the third conductor layer, and the fourth conductor layer, the substrate 5 is configured by stacking the conductor layers in the order of the first conductor layer, the second conductor layer. the third conductor layer, and the fourth conductor layer from a bottom side, and an insulating layer is provided between the two conductor layers stacked to be adjacent to each other. The first antenna 10 includes a first antenna element 10A and a second antenna element 10B that are provided at the different conductor layers. The first antenna element 10A is formed at the fourth conductor layer, and the second antenna element 10B is formed at the third conductor layer. The first antenna element 10A and the second antenna element 10B are each formed in a rectangular shape in a plan view, and are configured in such a way that in the plan view, a size (area) of the first antenna element 10A is larger than a size (area) of the second antenna element 10B. The second antenna element 10B is depicted by the broken lines in FIG. 2 for purpose of facilitating the understanding, and is not actually visible when the substrate 5 is viewed from a side of the surface 5A.

The first antenna element 10A and the second antenna element 10B differ from each other in a frequency at which the first antenna element 10A and the second antenna element 10B can transmit and receive radio waves. The first antenna element 10A and the second antenna element 10B are each electrically connected to the first conductor layer via through-holes TH. Capacitors can be each mounted on a surface included in the substrate 5 and opposite to the surface 5A in such a way as to extend from a land to a ground patter. The land extends from the through-hole TH. Impedances of the first antenna element 10A and the second antenna element 10B can be each adjusted by a capacitance value of the capacitor.

A conductor pattern of the first conductor layer and a conductor pattern of the second conductor layer have portions that face each other in the stacking direction in such a way as to sandwich the insulating layer provided between the first and second conductor layers. Thereby, in addition to capacitances of the above-described capacitors, a capacitance is formed by the conductor pattern of the first conductor layer, the conductor pattern of the second conductor layer, and the insulating layer. This capacitance also allows the impedances to be adjusted.

The third conductor layer includes a third layer pattern formation area in which the second antenna element 10B is formed, and a ground area arranged in such a way as to surround the third layer pattern formation area. A first layer pattern formation area that is included in the first conductor layer and in which the above-described conductor pattern is formed includes an overlapping area that overlaps with the second antenna element 10B in a plan view. This overlapping area at least partially includes a non-patterned area in which the first layer pattern is not formed. Thereby, electric lines of force are suppressed from being confined between the first antenna element 10A and the second antenna element 10B. Thus, efficient emission and incidence of a radio wave is allowed. The overlapping area corresponds to an area directly below the second antenna element 10B.

The second antenna 20 receives a radio wave from at least a lower side of the door 3 of the vehicle 2. A lower side of the door 3 of the vehicle 2 means a side of a road surface 200 (refer to FIG. 5) of a road on which the vehicle 2 is parked. Accordingly, the second antenna 20 receives a radio wave propagating through the air from a side of the road surface 200 of the road on which the vehicle 2 is parked.

In this embodiment, the second antenna 20 is configured as a Vivaldi antenna. The second antenna 20 is also configured to include a pattern formed in the substrate 5. In this embodiment, the first antenna 10 and the second antenna 20 are configured in the single substrate 5. The second antenna 20 includes a first antenna element 21 provided for antenna matching (impedance matching), and a second antenna element 22 for receiving a radio wave. The first antenna element 21 is formed in a square shape in a plan view in FIG. 2, but may be circular or rectangular. Naturally, the first antenna element 21 may have a shape of a triangle or an n-sided (n is an integer equal to or larger than five) polygon. The second antenna element 22 is formed in such a way as to extend from the first antenna element 21 to a side opposite to an end portion on which side the first antenna element 21 is provided in the substrate 5. The second antenna element 22 is configured in such a way as to have a width gradually increasing as a position shifts away from the first antenna element 21. The width of the second antenna element 22 is a width along a direction perpendicular to a direction in which the second antenna element 22 extends to the above-mentioned opposite side. In this embodiment, the width is set in such a way as to exponentially increase. The first antenna element 21 and the second antenna element 22 are formed at the first conductor layer. The second conductor layer, the third conductor layer, and the fourth conductor layer each include an area that overlaps with the first antenna element 21 and the second antenna element 22 and in which the conductor layer is removed.

As illustrated in FIG. 1, the substrate 5 includes the surface 5A along which the first antenna 10 and the second antenna 20 are formed, and the substrate 5 is provided on a rear end side in the vehicle 2 while the surface 5A faces a rear side in a traveling direction of the vehicle 2. Specifically, the substrate 5 is provided at a rear bumper 1B of the vehicle 2 while the surface 5A, which is included in the substrate 5 and along which the first antenna 10 and the second antenna 20 are formed, stands and faces a rear side of the vehicle 2. When the rear bumper 1B is made of a resin material, the substrate 5 may be provided inside the rear bumper 1B. Naturally, the substrate 5 may be provided in a state of being exposed from the rear bumper 1B.

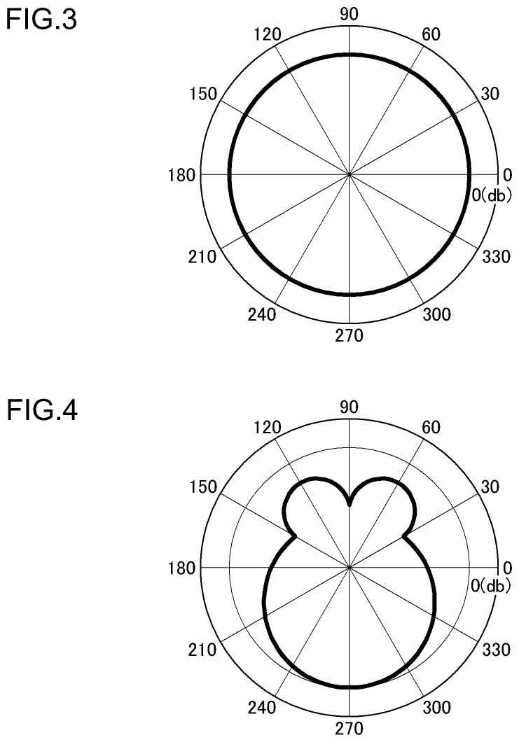

FIG. 3 illustrates a directivity characteristic of the first antenna 10. The first antenna 10 has the circular directivity characteristic as illustrated in FIG. 3. The first antenna 10 has a circular directivity characteristic (not illustrated in the drawings) also when the substrate 5 is viewed from a direction parallel to the surface 5A. Accordingly, the first antenna 10 has directivity for a radio wave from a lateral side (in this embodiment, a rear side of the vehicle 2).

The first antenna 10 is configured to be able to transmit a radio wave to a rear side of the vehicle 2 and transmit and receive a vertically polarized radio wave and a horizontally polarized radio wave. Thereby, the first antenna 10 can be used not only to detect the leg 4A of the person 4 but also to communicate with a portable terminal associated with the vehicle 2 and storing an electronic key.

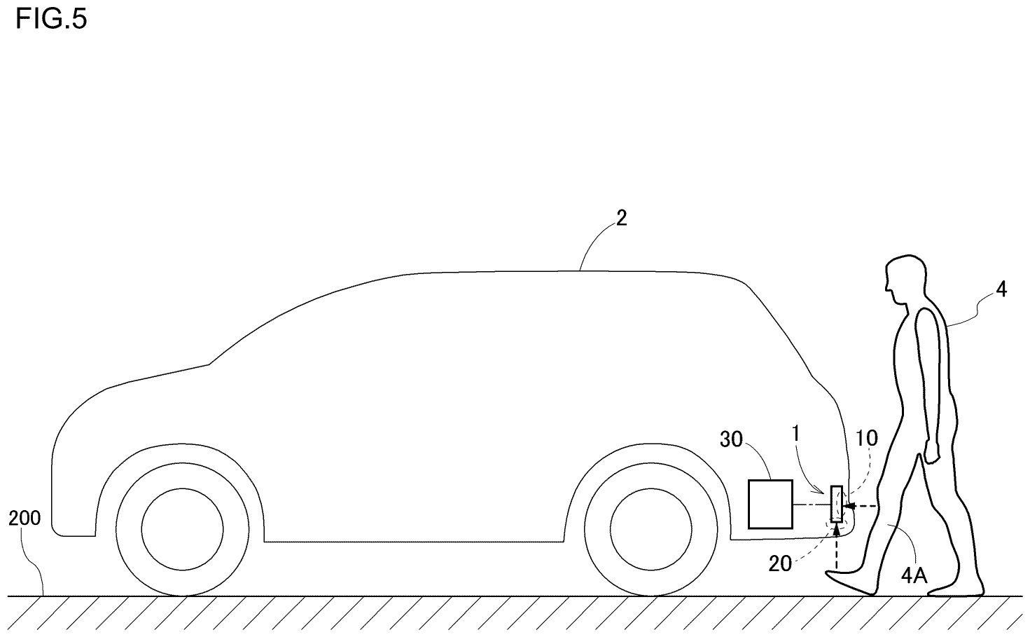

FIG. 4 illustrates a directivity characteristic of the second antenna 20. The second antenna 20 includes the second antenna element 22 as described above. As illustrated in FIG. 4, the second antenna 20 has strong directivity for the direction in which the second antenna element 22 extends (in FIG. 4, the direction along the line of 270 degrees), and weak directivity for the direction (in FIG. 4, in a range from 0 degrees to 180 degrees) to a side opposite to the direction in which the second antenna element 22 extends. The second antenna 20 has a significantly weak directivity characteristic (not illustrated) for the direction perpendicular to the surface 5A that is included in the substrate 5 and on which the second antenna 20 is provided. Accordingly, the second antenna 20 has directivity for a radio wave from a lower side (in this embodiment, a side of the road surface 200). Thus, the second antenna 20 is configured to be able to transmit a radio wave to a side of the road surface 200 and able to transmit and receive a polarized radio wave that oscillate parallel to the surface 5A.

FIG. 5 illustrates a mode of inputting an opening-closing instruction by a motion of the leg 4A of the person 4. As described above, the kick sensor 1 is provided on a rear end side in the vehicle 2.

The first antenna 10 receives a radio wave from a rear of the vehicle 2. In the example of FIG. 5, the first antenna 10 receives a radio wave from a shin portion of the leg 4A of the person 4. Meanwhile, the second antenna 20 receives a radio wave from a side of the road surface 200. In the example of FIG. 5, the second antenna 20 receives a radio wave from a toe portion of the leg 4A of the person 4. In this manner, the kick sensor 1 detects, in each of the first antenna 10 and the second antenna 20, an opening-closing instruction as a trigger for switching a state of the door 3 of the vehicle 2. Detection results of the first antenna 10 and the second antenna 20 are transmitted to the control unit 30. When both the first antenna 10 and the second antenna 20 receive radio waves within a predetermined time. the control unit 30 switches a state of the door 3 of the vehicle 2 from one of an opened door state and a closed door state to the other, or switches the door lock from one of an unlocking state and a locking state to the other.

In this manner, according to this kick sensor 1, a state of the door 3 or the door lock is changed when both the first antenna 10 and the second antenna 20 detect radio waves. Thereby, a state of the door 3 or the door lock can be suppressed from being changed due to erroneous detection, as compared to a configuration in which a state of the door 3 or the door lock is switched when one of the first antenna 10 and the second antenna 20 detects a radio wave.

In the kick sensor 1, each of the first antenna 10 and the second antenna 20 emits a radio wave at a predetermined time interval, and is then set to be able to receive the radio wave that has been emitted and reflected. The control unit 30 performs such switching of each of the first antenna 10 and the second antenna 20 between a state of emitting a radio wave and a state of being able to receive the radio wave. In other words, the first antenna 10 emits a radio wave to a rear side of the vehicle 2 at a predetermined time interval, and is set in a reception state of being able to receive a radio wave during a period from the time the first antenna 10 emits a radio wave to the next time the first antenna 10 emits a radio wave. The second antenna 20 emits a radio wave to a side of the road surface 200 at a predetermined time interval, and is set in a reception state of being able to receive a radio wave during a period from the time the second antenna 20 emits a radio wave to the next time the second antenna 20 emits a radio wave.

The kick sensor 1 configured as described above can detect a motion (action) of the leg 4A of the person 4 related to an opening-closing instruction made by the motion of the leg 4A of the person 4, even when the person 4 using the vehicle 2 is carrying luggage with both hands for example as illustrated in FIG. 1. Thereby; the kick sensor 1 can appropriately switch a state of the door 3 or the door lock of the vehicle 2.

### Alternative Embodiments

Next, alternative embodiments of the kick sensor 1 are described.

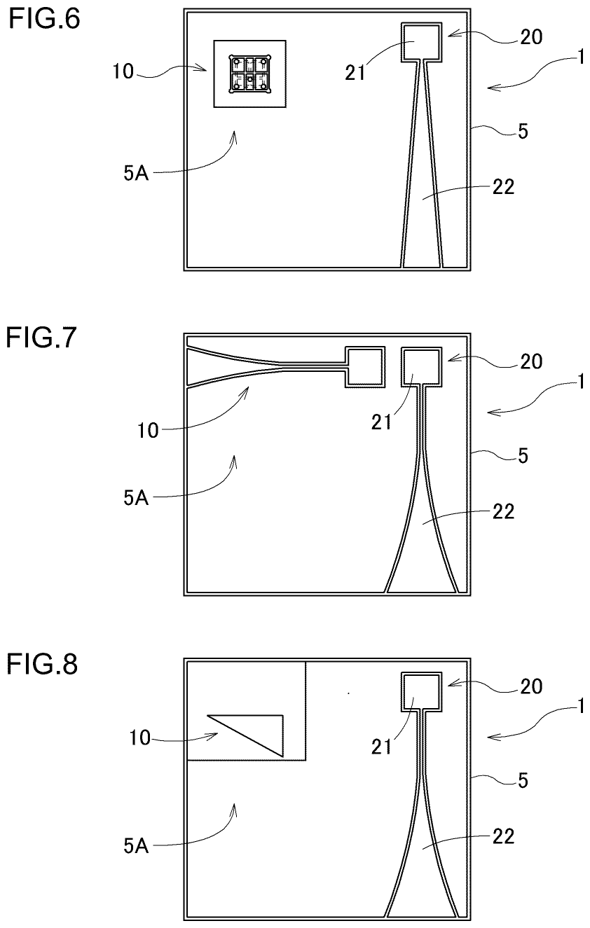

In the above-described embodiment, the second antenna 20 includes the first antenna element 21 and the second antenna element 22, and the second antenna element 22 is configured to has a width exponentially increasing as a position becomes separated from the first antenna element 21. However, the second antenna element 22 of the second antenna 20 may be configured to have a width linearly increasing as a position becomes separated from the first antenna element 21, as illustrated in FIG. 6.

In the above-described embodiment, the first antenna 10 is the patch antenna. However, the first antenna 10 may be constituted by a Vivaldi antenna as illustrated in FIG. 7. Alternatively, the first antenna 10 may be an antenna including an element portion that protrudes from a ground pattern as illustrated in FIG. 8.

In the above-described embodiment, each of the first antenna 10 and the second antenna 20 emits a radio wave at a predetermined time interval and is then set to be able to receive the radio wave that has been emitted and reflected. In another example, the control unit 30 may be configured to switch a state of the first antenna 10 and the second antenna 20 between a first state and a second state alternately. In the first state, one of the first antenna 10 and the second antenna 20 transmits a radio wave. In the second state, the other of the first antenna 10 and the second antenna 20 transmits a radio wave.

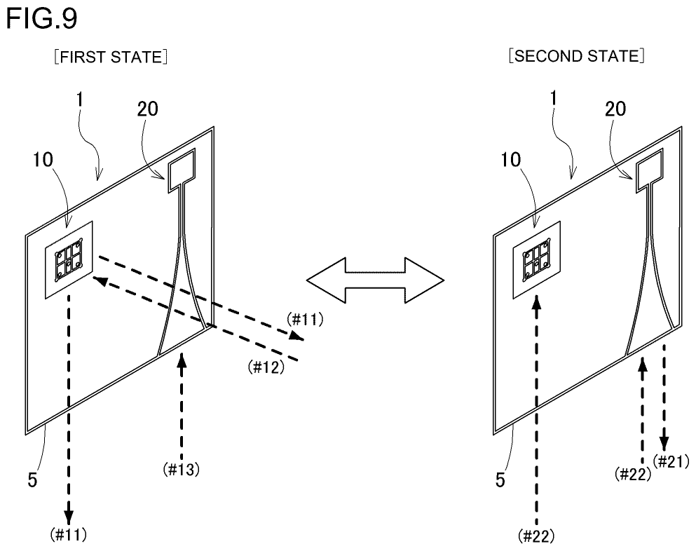

As illustrated in FIG. 9, in the first state, the first antenna 10 transmits a radio wave (#11) to a lateral side and a lower side of the vehicle 2, and the first antenna 10 receives a radio wave (#12) propagating from the shin portion of the leg 4A of the person 4 and depending on the transmitted radio wave, and the second antenna 20 receives a radio wave (#13) propagating from the toe portion of the leg 4A and depending on the transmitted radio wave. Meanwhile, in the second state, the second antenna 20 transmits a radio wave (#21) to a lower side of the vehicle 2, and the first antenna 10 and the second antenna 20 each receive a radio wave (#22) propagating from the toe portion of the leg 4A of the person 4 and depending on the transmitted radio wave. In this case, the second antenna 20 does not transmit a radio wave to a lateral side of the door 3, and thus, the first antenna 10 and the second antenna 20 are each unlikely to receive a radio wave from the side of a lateral side of the door 3.

In the first state, the control unit 30 may control the first antenna 10 to transmit a radio wave at a predetermined time interval for example, and may set both the first antenna 10 and the second antenna 20 in a reception state during a period from the time the radio wave is transmitted to the next time the radio wave is transmitted. In the second state, the control unit 30 may control the second antenna 20 to transmit a radio wave at a predetermined time interval, and may set both the first antenna 10 and the second antenna 20 in a reception state during a period from the time the radio wave is transmitted to the next time the radio wave is transmitted. In this configuration, the number of times the radio wave is transmitted can be set smaller than that in the case where the first antenna 10 and the second antenna 20 each transmit and receive a radio wave. Thus, electric power consumption can be reduced.

In this case, the control unit 30 may be configured in such a way as to determine whether a motion of the leg 4A of the person 4 has been made, based on a ratio between intensity of the radio wave received by the first antenna 10 and intensity of the radio wave received by the second antenna 20. For example, when a ratio between intensity of the radio wave received by the first antenna 10 and intensity of the radio wave received by the second antenna 20 is within a range including a predetermined value, and the intensity of the radio wave received by the first antenna 10 and the intensity of the radio wave received by the second antenna 20 are each larger than a predetermined value, it can be determined that the person 4 intending to switch a state of the door 3 or the door lock of the vehicle 2 has made the motion of the leg 4A on a lateral side and a lower side of the door 3. Thus, erroneous detection can be prevented.

### Outline of Above-Described Embodiments

The following outlines the kick sensor 1 described above.

(1) The kick sensor 1 is provided in the vehicle 2, and detects a motion of the leg 4A of the person 4 that triggers the control of the door 3 of the vehicle 2. The kick sensor 1 includes the first antenna 10 that receives a radio wave from at least a lateral side of the door 3 of the vehicle 2, and the second antenna 20 that receives a radio wave from at least a lower side of the door 3 of the vehicle 2.

According to this configuration, on condition that the first antenna 10 receives a radio wave from a lateral side and the second antenna 20 receives a radio wave from a lower side, a state of the door 3 of the vehicle 2 can be switched from one of an opened state and a closed state to the other, or a state of the door lock can be switched from one of a locking state and an unlocking state to the other. For this reason, erroneous detection can be prevented from occurring due to an animal passing near the kick sensor 1 or a person passing or moving near the kick sensor 1 without intention of switching a state of the door 3 or the door lock of the vehicle 2 for example, in contrast to the case where on condition that only one of reception of a radio wave from a lateral side and reception of a radio wave from a lower side is satisfied, a state of the door 3 of the vehicle 2 is switched from one of an opened state and a closed state to the other, or a state of the door lock is switched from one of a locking state and an unlocked state to the other. Thus, the kick sensor 1 can appropriately switch a state of the door 3 or the door lock of the vehicle 2 by detecting a motion (action) of the leg 4A of the person 4.

(2) In the kick sensor 1 according to (1), the first antenna 10 may have directivity for a radio wave from a lateral side.

According to this configuration, the first antenna 10 can appropriately receive a radio wave from a lateral side. Thus, the kick sensor 1 can appropriately y detect the shin portion of the leg 4A of the person 4.

(3) In the kick sensor 1 according to (1) or (2), the second antenna 20 may have directivity for a radio wave from a lower side.

According to this configuration, the second antenna 20 can appropriately receive a radio wave from a lower side. Thus, the kick sensor 1 can appropriately y detect the toe portion of the leg 4A of the person 4.

(4) In the kick sensor 1 according to any one of (1) to (3), the first antenna 10 and the second antenna 20 may be configured as patterns formed in a single substrate 5.

According to this configuration, when the substrate 5 is configured as a printed circuit board for example, forming the first antenna 10 and the second antenna 20 in the single printed circuit board enables the kick sensor 1 to be configured inexpensively.

(5) In the kick sensor 1 according to (4), the substrate 5 may include the surface 5A along which the first antenna 10 and the second antenna 20 are formed, and the substrate 5 is provided on a rear end side in the vehicle 2 while the surface 5A faces a rear side in a traveling direction of the vehicle 2.

According to this configuration, the kick sensor 1 can be used to control opening and closing of the back door 3A (rear gate) of the vehicle 2. Thus, the shin portion of the leg 4A stretched toward the kick sensor 1 from a rear side of the vehicle 2 can be detected by the first antenna 10, and the toe portion of the leg 4A protruded to a lower side of the door 3 from a rear side of the vehicle 2 can be detected by the second antenna 20.

(6) In the kick sensor 1 according to any one of (1) to (5), the first antenna 10 may be able to transmit and receive a vertically polarized radio wave and a horizontally polarized radio wave.

For example, when a portable terminal is used to lock or unlock a lock mechanism of the vehicle 2 by an electronic key, a radio wave from the portable terminal is usually a horizontally polarized radio wave. In view of it, configuring the first antenna 10 to be able to transmit and receive a vertically polarized radio wave and a horizontally polarized radio wave allows the first antenna 10 to be used not only to detect the leg 4A of the person 4 for switching a state of the door 3 of the vehicle 2 from one of an opened state and a closed state to the other, but also to communicate with the portable terminal.

(7) In the kick sensor 1 according to any one of (1) to (6), the first antenna 10 may be able to transmit a radio wave to a lateral side, and the second antenna 20 may be able to transmit a radio wave to a lower side.

According to this configuration, the first antenna 10 and the second antenna 20 can be used also to transmit radio waves for detecting the person 4. Thus, the transmission-reception antenna can be configured inexpensively and compactly.

(8) The kick sensor 1 according to any one of (1) to (7) may further include a control unit 30 that switches a state of the first antenna 10 and the second antenna 20 between the first state and the second state alternately. In the first state, one of the first antenna 10 and the second antenna 20 transmits a radio wave. In the second state, another of the first antenna 10 and the second antenna 20 transmits a radio wave.

According to this configuration, in the first state, the first antenna 10 can transmit a radio wave at a predetermined time interval for example, and both the first antenna 10 and the second antenna 20 can be set in the reception state during a period from the time the radio wave is transmitted to the next time the radio wave is transmitted. In the second state, the second antenna 20 can transmit a radio wave at a predetermined time interval, and both the first antenna 10 and the second antenna 20 can be set in the reception state during the period from the time the radio wave is transmitted to the next time the radio wave is transmitted. In this configuration, the number of times the radio wave is transmitted can be set smaller than that in the case where the first antenna 10 and the second antenna 20 each transmit and receive a radio wave. Thus, electric power consumption can be reduced.

(9) The kick sensor 1 according to (8) may determine whether a motion of the leg 4A of the person 4 is made, based on a ratio between intensity of the radio wave received by the first antenna 10 and intensity of the radio wave received by the second antenna 20.

According to this configuration, for example, when a ratio (which is a result of dividing intensity of the radio wave received by the first antenna 10 by intensity of the radio wave received by the second antenna 20) of intensity of the radio wave received by the first antenna 10 to intensity of the radio wave received by the second antenna 20 is larger than a predetermined value, it can be determined that the motion has occurred on a lateral side of the door 3. When a ratio (which is a result of dividing intensity of the radio wave received by the first antenna 10 by intensity of the radio wave received by the second antenna 20) of intensity of the radio wave received by the first antenna 10 to intensity of the radio wave received by the second antenna 20 is smaller than a predetermined value, it can be determined that the motion has occurred on a lower side of the door 3. In contrast to this, a ratio (which is calculated by dividing intensity of the radio wave received by the first antenna 10 by intensity of the radio wave received by the second antenna 20) of intensity of the radio wave received by the first antenna 10 to intensity of the radio wave received by the second antenna 20 is within a range including a predetermined value, and the intensity of the radio wave received by the first antenna 10 and the intensity of the radio wave received by the second antenna 20 are each larger than a predetermined value, it can be determined that the person 4 intending to switch a state of the door 3 or the door lock of the vehicle 2 has made the motion of the leg 4A on a lateral side and a lower side of the door 3. Thus, erroneous detection can be prevented.

### Industrial Applicability

The technique according to this disclosure can be applied to a kick sensor provided in a vehicle and detecting a motion of a leg of a person that triggers control of the a door of the vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly; it is expressly intended that all such variations, changes and equivalents which fall within the spirit and scope of the present invention as defined in the claims, be embraced thereby.

1. A kick sensor to be provided in a vehicle and detecting a motion of a leg of a person that triggers control of a door of the vehicle, the kick sensor comprising:
a first antenna that receives a radio wave from at least a lateral side of the door of the vehicle; and
a second antenna that receives a radio wave from at least a lower side of the door of the vehicle.

2. The kick sensor according to claim 1, wherein the first antenna has directivity for the radio wave from the lateral side.

3. The kick sensor according to claim 1, wherein
the second antenna has directivity for the radio wave from the lower side.

4. The kick sensor according to claim 1, wherein
the first antenna and the second antenna are configured as patterns formed in a single substrate.

5. The kick sensor according to claim 4, wherein
the substrate includes a surface along which the first antenna and the second antenna are formed, and the substrate is provided on a rear end side in the vehicle while the surface faces a rear side in a traveling direction of the vehicle.

6. The kick sensor according to claim 1, wherein
the first antenna can transmit and receive a vertically polarized radio wave and a horizontally polarized radio wave.

7. The kick sensor according to claim 1, wherein,
the first antenna can transmit a radio wave to the lateral side, and
the second antenna can transmit a radio wave to the lower side.

8. The kick sensor according to claim 1 further comprising
a control unit that switches a state of the first antenna and the second antenna between a first state and a second state alternately, wherein, in the first state, one of the first antenna and the second antenna transmits the radio wave, and in the second state, another of the first antenna and the second antenna transmits the radio wave.

9. The kick sensor according to claim 1, wherein
the kick sensor determines whether a motion of the leg of the person is made, based on a ratio between intensity of the radio wave received by the first antenna and intensity of the radio wave received by the second antenna.

10. The kick sensor according to claim 2, wherein
the second antenna has directivity for the radio wave from the lower side.

11. The kick sensor according to claim 2, wherein
the first antenna and the second antenna are configured as patterns formed in a single substrate.

12. The kick sensor according to claim 11, wherein
the substrate includes a surface along which the first antenna and the second antenna are formed, and the substrate is provided on a rear end side in the vehicle while the surface faces a rear side in a traveling direction of the vehicle.

13. The kick sensor according to claim 2, wherein
the first antenna can transmit and receive a vertically polarized radio wave and a horizontally polarized radio wave.

14. The kick sensor according to claim 2, wherein,
the first antenna can transmit a radio wave to the lateral side, and
the second antenna can transmit a radio wave to the lower side.

15. The kick sensor according to claim 2 further comprising
a control unit that switches a state of the first antenna and the second antenna between a first state and a second state alternately, wherein, in the first state, one of the first antenna and the second antenna transmits the radio wave, and in the second state, another of the first antenna and the second antenna transmits the radio wave.

16. The kick sensor according to claim 2, wherein
the kick sensor determines whether a motion of the leg of the person is made, based on a ratio between intensity of the radio wave received by the first antenna and intensity of the radio wave received by the second antenna.
